(19) United States
(12) Patent Application Publication
(10) Pub. No.: US 2017/0165860 A1
(43) Pub. Date: Jun. 15, 2017

(54) DEVICE FOR RELEASING SECTIONS FROM A MATERIAL WEB

(71) Applicant: Harro Hoefliger Verpackungsmaschinen GmbH, Allmersbach im Tal (DE)

(72) Inventors: Andreas SIGNORE, Allmersbach im Tal (DE); Manfred SAMP, Allmersbach im Tal (DE)

(73) Assignee: Harro Hoefliger Verpackungsmaschinen GmbH, Allmersbach im Tal (DE)

(21) Appl. No.: 15/376,803

(22) Filed: Dec. 13, 2016

(30) Foreign Application Priority Data
Dec. 14, 2015 (DE) 20 2015 008 522.9

(51) Int. Cl. B26D 7/18; B65H 35/00; B65H 20/12; B26D 7/32

(52) U.S. Cl. CPC B26D 7/1863; B26D 7/32; B26D 7/1854; B65H 35/0006; B65H 20/12; B65H 2301/51537; B65H 2406/33

(57) ABSTRACT

A device for releasing sections from a material web has a vacuum cutting cylinder and a counter cylinder for cutting the sections. The device also has a vacuum transfer roll for removing the sections from the vacuum cutting cylinder and a conveyor belt, onto which the sections are capable of being deposited from the vacuum transfer roll.

### CROSS REFERENCE TO RELATED APPLICATIONS

Applicant claims priority under 35 U.S.C. §119 of German Application No. 20 2015 008 522.9 filed Dec. 14, 2015, the disclosure of which is incorporated by reference.

### BACKGROUND OF THE INVENTION

1. Field ofthe Invention

The present invention relates. to a device for releasing sections from a material web. The material web can be a single-layer or a multi-layer material and can be present wound, for example, onto a roil body. The material web can be drawn from this roll body and can be processed in a phased or continuously operating process. Such like web-processing processes are used, for example, in the production of wound dressings or other therapeutic dressings. It may be necessary in this case to release sections from the material web, in order to position said sections on further material webs.

2. Prior Art

The punching of sections from a material web is already a familiar concept. Very high punching forces may he necessary, depending on the nature and thickness of the material web to be cut and the size and length of the punching line. The corresponding punching devices must then be dimensioned in a correspondingly sturdy manner. The heavier the punching devices become, the less suitable they are to be displaced during the punching operation together with the material web as it moves in the transport direction. Punching devices are thus suitable, predominantly for stationary punching operations.

Previously disclosed in DE 299 11 914 U1 is a device for releasing sections, in which a cutting edge is drawn through the material web in a pulling cut. Also disclosed in this document is a device, in which a cutting edge is pushed through the material web in a rolling motion. The required forces, which must be applied by the device, are relatively small in this case, so that the corresponding devices can be of relatively slim and lightweight configuration and are thus capable of being displaced together with the web as it moves in the transport direction during the separation process. However, only relatively large sections can be separated from the material web with both devices.

### SUMMARY OF THE INVENTION

On the basis of the previously known prior art, the invention has as its object to propose an improved device for releasing sections from a material web, which device is also suitable for very small sections and enables continuous processing.

These and other objects are achieved by a device according to the invention. Desirable further developments of the invention are set forth below.

The inventive device for releasing sections from a material web has a vacuum cutting cylinder and a counter cylinder, by means of which the sections are cut. Present in addition is a vacuum transfer roll, by means of which the cut sections can be removed from the vacuum cutting cylinder. The cut sections are then deposited from the vacuum transfer roll onto a conveyor belt, so that the sections can undergo further processing.

The combination of the three rolls—being the vacuum cutting cylinder, the counter cylinder and the vacuum transfer cylinder—also enables small product sizes measuring only about ten by ten millimetres or even smaller to be cut from the material web. The sections can be used, for example, as an active substance reservoir in transdermal therapeutic systems. Suchlike dressings are becoming increasingly small, so that increasingly small sections require to be cut from the material web.

In particular in the case of material webs containing an adhesive substance, the transfer of the cut sections from the vacuum cutting cylinder directly onto a conveyor belt is a critical step, since this removal is often difficult and leads to an increased rate of rejects. The cut sections can thus continue to adhere in the vacuum cutting cylinder, which can hamper their transfer to the conveyor belt. The use of the vacuum transfer roll, on the other hand, permits the clean and precise removal of the cut products from the vacuum cutting cylinder and the precise depositing of the cut products on the conveyor belt.

In the case of the production of transdermal therapeutic systems in particular, the material web containing the active substance is so valuable that the fewest possible offcuts and the least possible wastage should be generated in conjunction with the cutting to size of the required sections. For this reason, the smallest possible spacing should be present between the sections that are required for further processing. The sections thus adjoin one another directly as a rule in the running direction of the material web and are separated from one another only by the cutting line. So-called cold flowing of the adhesive material may occur, however, in particular when use is made of material webs containing an adhesive substance. Cold flowing causes the adhesive material to flow outwards slightly, so that the neighbouring sections adhere to one another once more if they are no longer separated from one another by the cut edges of the vacuum cutting cylinder. In an advantageous embodiment of the inventive device, the speed of rotation of the vacuum transfer roll can thus be slightly greater than the speed of rotation of the vacuum cutting cylinder. As a result, the cut sections are spread slightly apart in the running direction, so that the adhesion of the sections due to cold flowing is no longer possible. The slightly greater speed of rotation of the vacuum transfer roll can preferably be provided by an independent motor drive for the vacuum transfer roll.

The transfer of the cut sections from the vacuum cutting cylinder to the vacuum transfer roll can be performed by differently set vacuums for the two rolls. It may thus be sufficient if the vacuum transfer roll, exhibits a higher vacuum than the vacuum cutting cylinder, in order to ensure the precise removal of the sections from the vacuum cutting cylinder. In particular in the case of material webs containing an adhesive substance, however, it may be advantageous to connect the vacuum cutting cylinder to a compressed air channel, so that the transfer of the cut sections can be facilitated and accelerated by one or a number of pulses of compressed air.

In order to permit a continuous production process with the greatest possible web speed, a fixed hollow cylinder may be present beneath the outer surface of the vacuum cutting cylinder, which hollow cylinder in cross section exhibits at least two chambers. One of the two chambers can be. connected to a vacuum pump, while the other of the two chambers can be connected to a compressed air channel. The vacuum cutting cylinder is able in this way permanently and reliably to exhibit a constant vacuum in the region of the counter cylinder, so that a precise cutting result can be achieved. Normal pressure or even a slight overpressure may be present, on the other hand, in the region of the vacuum transfer roll, so that simple and reliable removal of the cut products from the vacuum cutting cylinder is possible.

The transfer of the cut regions from the vacuum transfer roll onto the conveyor belt can preferably be performed by a pulse of compressed air. The vacuum transfer roll can be connected for this purpose to a compressed air channel, so that a vacuum is no longer present on the vacuum transfer roll in the transfer region between the vacuum transfer roll and the conveyor belt. In an advantageous embodiment, a fixed hollow cylinder may be present for this purpose beneath the outer surface in the case of the vacuum transfer roll, which fixed hollow cylinder in cross section exhibits at least two chambers. One of the two chambers can be connected to a vacuum pump, whereas the other of the two chambers can be connected to a compressed air channel. In this way, the vacuum transfer roll in the region of the vacuum cutting cylinder is able permanently and reliably to exhibit a constant vacuum, so that the reproducible and reliable removal of the cut regions from the vacuum cutting cylinder is possible. Normal pressure or even a slight overpressure may be present, on the other hand, in the region of the vacuum transfer roll, so that the simple and reliable transfer of the cut products onto the conveyor belt is possible.

In an advantageous embodiment, the conveyor belt may be configured as a vacuum conveyor belt. This permits the reliable transport of the cut products. In particular in the case of products made from material webs containing an adhesive substance, any shifting of the cut products on the conveyor belt could result in the subsequent adhesion of the cut products, with the result that they can no longer undergo further processing and must be disposed of as rejects. Such shifting can be prevented by the use of a vacuum conveyor belt.

In a particularly preferred embodiment, the transport speed of the conveyor belt can be slightly greater than the speed of rotation of the vacuum transfer roll. As a result, the cut sections are spread further apart in the transport direction, so that the risk of adhesion of the sections due to cold flowing of the adhesive material can be further reduced.

Further advantages and characterizing features of the invention can be appreciated from the characterizing features that are indicated in more detail in the claims, and from the following illustrative embodiment.

### BRIEF DESCRIPTION OF THE DRAWING

The invention is described and explained below on the basis of the illustrative embodiment illustrated in the drawing. In the drawing:

FIG. 1 depicts a perspective view of the inventive device for releasing sections from a material web, and

FIG. 2 depicts a perspective view from the side of the inventive device according to FIG. 1.

### DETAILED DESCRIPTION OF THE PREFERRED EMBODIMENTS

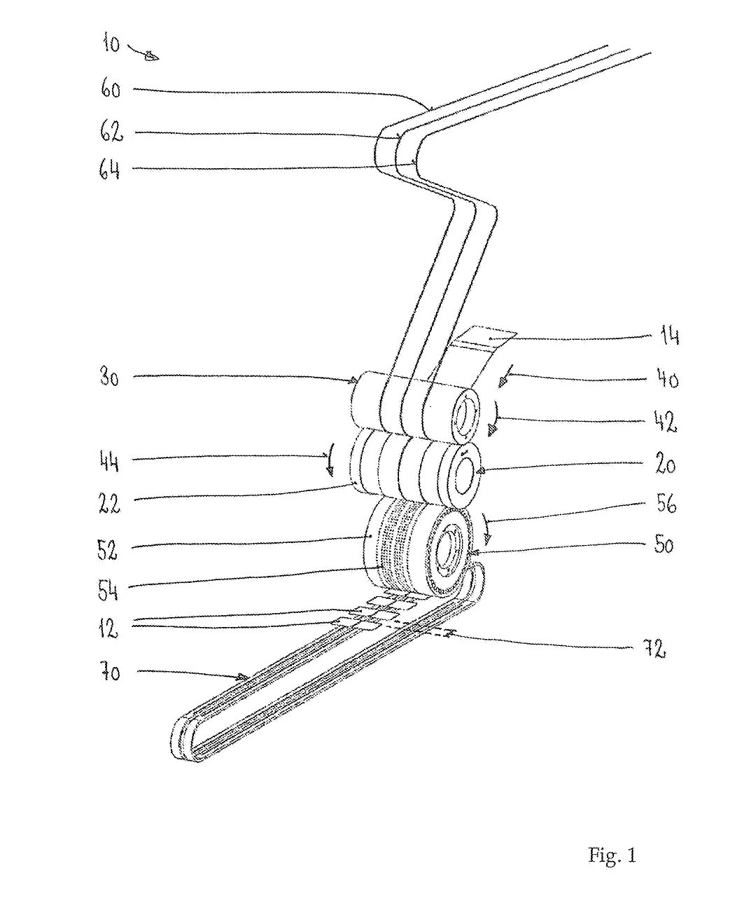

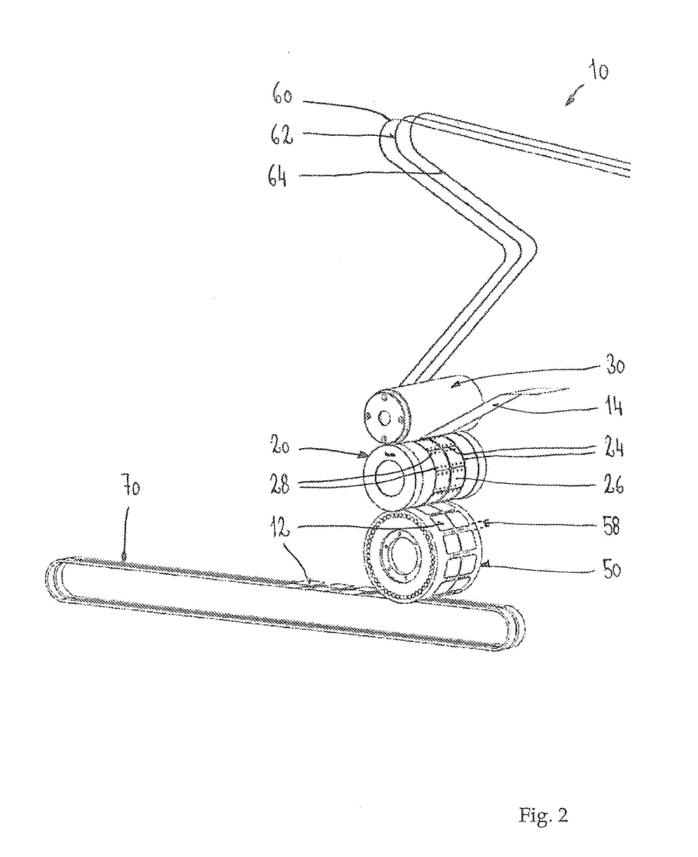

The inventive device 10 for releasing sections 12 from a material web 14 is illustrated in perspective in FIGS. 1 and 2. The device 10 has a vacuum cutting cylinder 20, which is mounted in a rotatable manner and is displaced by means of a motor drive that is not illustrated here. The outer surface 22 of the vacuum cutting cylinder 20 has a number of cutting edges 24, which form a number of identical depressions 26. The outer shape of the depressions 26 corresponds to the shape of the sections 12 to be cut. A number of openings 28 are present in each depression 26. The openings 28 are connected—depending on the rotational position of the vacuum cutting cylinder 20—to a compressed air channel or to a vacuum line.

The vacuum cutting cylinder 20 interacts with a counter cylinder 30. The material web 14 is supplied to the device 10 via transport rollers that are not illustrated here and arrives in the transport direction 40 between the vacuum cutting cylinder 20 and the counter cylinder 30. In the present example, the direction of rotation 42 of the counter cylinder 30 runs in a clockwise direction, whereas the direction of rotation 44 of the vacuum cutting cylinder 20 runs in an anticlockwise direction. As the material web 14 is conveyed between the counter cylinder 30 and the vacuum cutting cylinder 20, the individual sections 12 are cut from the material web 14. The sections 12 are initially transported onwards into the depressions 26 in the vacuum cutting cylinder 20, before being transferred to the vacuum transfer roll 50.

The vacuum transfer roll 50 has in its otherwise smooth outer surface 52 a multiplicity of openings 54, which can be. acted upon by compressed air or by a vacuum, The vacuum transfer roll 50 is mounted in a rotatable manner and is driven in a rotatable manner by its own motor drive. The direction of rotation 56 of the vacuum transfer roll 50 runs in the clockwise direction in the present example. The speed of rotation of the vacuum transfer roll 50 can be selected on account of the separate motor drive regardless of the speed of rotation of the vacuum cutting cylinder 20. In the present example, the speed of rotation of the vacuum transfer roll 50 is slightly greater than the speed of rotation of the vacuum cutting cylinder 20. It is thus possible to separate the cut sections 12 from one another by a certain amount 58 at the time of their transfer to the vacuum transfer roll 50, when viewed in the direction of transport, and to spread them apart in this way. Two adjacent sections 12 in the direction of transport thus no longer lie immediately after one another on the vacuum transfer roll, and in point of fact a small distance (amount 58) is present between them. This small distance reduces the risk of the sections 12 sticking together again due to the cold flowing of the adhesive present in the material web 14 and no longer being capable of being separated cleanly from one another at a later time.

It is thus not necessary to provide a distance between two sections 12 lying behind one another in the direction of transport 40 of the material web 14 already when cutting with the vacuum cutting cylinder 20, since said distance can be produced subsequently by the transfer to the vacuum transfer roll 50. This reduces the non-reusable remainder of the material web 14, so that the latter consists only of three narrow strips 60, 62, 64.

The two edge strips 60, 64 are required in order to be able to cut out slightly rounded sections 12 at the corners. In addition, no edge strips 60, 64 would be necessary to the extent that it is possible to dispense with the roundings of the corner regions. The middle strip 62. in the present example is required in order likewise to be able to ensure a certain distance between two neighbouring sections 12 in the longitudinal direction of the vacuum cutting cylinder 20, so that these are not able to adhere to one another once more due to cold flowing. This can result in more or fewer central strips 62, depending on the width of the material web 14 and the product size of the sections 12.

The removal of the sections 12 from the depressions 26 of the vacuum cutting cylinder usually requires the presence of a vacuum on the vacuum transfer roll 50. Depending on the material of the material web 14, it may be sufficient if the vacuum of the vacuum transfer roll 50 is greater than the vacuum of the vacuum cutting cylinder 20. In the event of this difference in pressure not being sufficient, the vacuum of the vacuum cutting cylinder 20 can be increased in the transfer region between the vacuum transfer roll 50 and the vacuum cutting cylinder 20. A pulse of compressed air could also take place, if necessary, in order to eject the cut sections 12 from the depressions 26 and to transfer them rapidly and precisely onto the vacuum transfer roll 50.

The cut sections 12 are transferred from the vacuum transfer roll 50 onto a vacuum conveyor belt 70. The transport speed of the vacuum conveyor belt 70 is slightly greater in the present case than the speed of rotation of the vacuum transfer roll 50. As a result, the distance 72 between two sections 12 lying one after the other on the vacuum conveyor belt 70 is slightly larger than the distance 58 between two sections 12 on the vacuum transfer roll 50. This can further reduce the risk of adhesion due to cold flowing.

The vacuum conveyor belt 70 can then transfer the cut sections 12 to further web-processing stations, in order to process the sections 12 further, for example into transdermal therapeutic dressings. Because of the resulting small amount of waste, the device 10 is particularly suitable if the material web contains the therapeutic active substance, since suchlike material webs are correspondingly cost-intensive and should be optimally utilized.

Different vacuum cutting cylinders 20 may be utilized in the inventive device 10 depending on the size and shape of the. desired sections 12. The storage of the vacuum cutting cylinder 20 can be selected so that vacuum cutting cylinders 20 of different diameters can also be utilized in the device without major problems, so that a rapid change to the format of the device 10 is possible.

What is claimed is:

1. device (10) for releasing sections (12) from a material web (14), having a vacuum cutting cylinder (20) and a counter cylinder (30) for cutting the sections (12),
having a vacuum transfer roll (50) for removing the sections (12) from the vacuum. cutting cylinder (20),
having a conveyor belt (70), onto which the sections (12) are capable of being deposited from the vacuum transfer roll (50).

2. The device as claimed in claim 1, wherein
the speed of rotation of the vacuum transfer roll (50) is greater than the speed of rotation of the vacuum cutting cylinder (20).

3. The device as claimed in claim, wherein
a first motor drive is present, by means of which the vacuum cutting cylinder (20) is capable of being driven in a rotatable manner, and
a second motor drive is present, by means of which the vacuum transfer roll (50) is capable of being driven in a rotatable manner.

4. The device as claimed in claim 1, wherein
the vacuum cutting cylinder (20) is connected to a compressed air channel.

5. The device as claimed in claim 4, wherein
a fixed hollow cylinder is present beneath the outer surface (22) of the vacuum cutting cylinder (20),
the fixed hollow cylinder in cross section exhibits at least two chambers,
one of the at least two chambers is connected to a vacuum pump, and
the other of the at least two chambers is connected to a compressed air channel.

6. The device as claimed in claim 1, wherein
the vacuum transfer roll (50) is connected to a compressed air channel.

7. The device as claimed in claim 6, wherein
a fixed hollow cylinder is present beneath the outer surface (52) of the. vacuum transfer roll (50),
the fixed hollow cylinder in cross section exhibits at least two chambers,
one of the at least two chambers is connected to a vacuum pump, and
the other of the at least two chambers is connected to a compressed air channel.

8. The device as claimed in claim 1, wherein
the conveyor belt is configured as a vacuum conveyor belt (70).

9. The device as claimed in claim 1, wherein
the transport speed of the conveyor belt (70) is greater than the speed of rotation of the vacuum transfer roll (50).
